(19) United States
(12) Patent Application Publication
(10) Pub. No.: US 2008/0069086 A1
(43) Pub. Date: Mar. 20, 2008

(54) Mobile Communication System Based On Ip And Session Initiation Method Thereof

(76) Inventors: Dong-Jin Shin, Daejeon-city (KR); Ji-Soo Park, Daejeon-city (KR); In-Seong Park, Daejeon-city (KR); Moon-Soo Jang, Daejeon-city (KR); Pyeong-Jung Song, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 11/719,918

(22) PCT Filed: Nov. 22, 2005
(86) PCT No.: PCT/KR05/03935

§ 371 Date: May 22, 2007

(30) Foreign Application Priority Data
Dec. 13, 2004 (KR) 10-2004-0104852
Jun. 7, 2005 (KR) 10-2005-0048368

(51) Int. Cl. H04L 12/56; H04Q 7/20

(52) U.S. Cl. 370/352; 455/445; 455/466

(57) ABSTRACT

The present invention relates to an internet protocol (IP) mobile communication system and a session initiation method thereof. In the IP mobile communication system, a session initiation process using a session initiation protocol is performed for real-time mobile multimedia communication. At this time, not only multimedia codec but also session and quality of service (QoS) information is negotiated from a transmitting terminal to a receiving terminal, and is negotiated between relating network elements. An access manager controls a mobile access router which is a gateway of an access network according to the negotiated session and QoS information. Therefore an additional QoS negotiation process is not necessary for a session guaranteeing the QoS between a terminal and the mobile access router, between the mobile access routers, and between the mobile access router and the receiving terminal.

### TECHNICAL FIELD

The present invention relates to a mobile communication system based on an internet protocol (IP). More particularly, the present invention relates to an IP mobile communication system and a method for performing session initiation by using session initiation protocol (SIP) so as to perform real-time voice and image communication in the IP-based mobile communication system.

### BACKGROUND ART

A session initiation protocol (SIP) and a session description protocol (SDP) have been suggested by an internet engineering task force (IETF) for developing and promoting internet standards, and these are used as signaling protocols for providing multimedia services including a voice over IP (VoIP). The SIP is a text-based protocol including the hyper text transfer protocol, which has been used for performing session initiation in various technical fields including an internet telephone technique, and the SIP provides personal mobility for accessing services at any time and any place by using an address type using a uniform resource identifier (URI).

In addition, a 3rd generation partnership project (3GPP) has studied a 3rd generation mobile communication service or a mobile communication service thereafter to provide not only voice services but also worldwide data services. Specifically, a general packet radio service (GPRS) system suggested by a 3GPP Release 5 uses a radio session control protocol including a session management (SM) for a packet-based multimedia service, and uses SIP/SDP suggested by the IETF for IP-based real-time multimedia session control.

Following the above trend, studies on a multimedia session initiation process using the SIP have been ongoing. In ongoing studies by a standard group, a session quality for a user's preferred call setup is guaranteed from a starting terminal to a router or a gateway of a network and from the starting terminal to an ending terminal since a method for negotiating network resource based on codec types has been suggested to perform the multimedia session initiation guaranteeing an end-to-end quality of service (QoS). In the studies, not only the codec type has been considered but also a QoS negotiation (i.e., a resource reservation protocol (RSVP) or a differentiated service (Differentiated service)) and network resource negotiation have been considered for an additional network resource negotiation.

After negotiating the session initiation, an end-to-end QoS begins to be negotiated between the starting end, the gateway or access router following a network traffic path, and the ending end by using negotiated information. An integrated service (IntServ) method and a differentiated service (DiffServ) method are used for the end-to-end QoS negotiation. Accordingly, one of the above methods or a combined method according to the network environment is used to satisfy the end-to-end QoS.

However, conventionally, the end-to-end QoS negotiation process for performing the session initiation guaranteeing the QoS between the mobile access router and the receiving terminal is performed after the negotiation for the session initiation is performed. Accordingly, there has been a problem in that the entire session initiation time and process are increased and are complex since the number of the protocol messages exchanged between the terminal and the radio station and a time for processing the protocol message are increased.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a mobile communication system for efficiently performing real-time voice and image communication and satisfying the QoS in the IP-based mobile communication system and a session initiation method thereof.

### Technical Solution

In an exemplary session initiation method of an internet protocol (IP) mobile communication system having an access network connected between a terminal and a core network, the access network includes a radio station wirelessly accessed to the terminal, a gateway is connected to the radio station to perform a routing function, and an access manager controls a network access through the gateway. In the method, a) a radio control channel for transmitting a message according to a service request of the terminal is established, b) a session initiation request is received from the terminal through the established radio control channel, messages between the terminal and a serving-call session control function (S-CSCF) unit of the core network are exchanged through the gateway, and a radio link session control process, resource allocation, and quality of service (QoS) negotiation are concurrently performed. An exemplary internet protocol (IP) mobile communication system connected between a mobile communication terminal and a core network, the IP mobile communication system includes a gateway and an access manager. The gateway performs a routing function, and is connected to the radio station accessed to the mobile communication terminal. The access manager receives a session initiation request of the terminal, exchanges messages between a serving-call session control function (S-CSCF) unit of the core network and the terminal through the gateway, and concurrently performs a radio session control process, resource allocation, and QoS negotiation.

### ADVANTAGEOUS EFFECTS

According to the exemplary embodiment of the present invention, the session initiation and the QoS negotiation are concurrently performed by using the QoS information transmitted in the session initiation process in the IP mobile communication system when the session initiation for the real-time mobile multimedia communication including the voice and image communication is performed by using the SIP. Therefore the multimedia session initiation process may be reduced since the common internet QoS negotiation process is eliminated.

More specifically, the multimedia communication for having the simplified session initiation process and guaranteeing the effective end-to-end QoS may be performed since the access manager of the access network transmits the information obtained in the session initiation and QoS negotiation processes to the mobile access router which is a traffic path, and the mobile access router allocates network resources so as to guarantee the QoS for the session to be initiated by using the information.

### BRIEF DESCRIPTION OF THE DRAWINGS

FIG. 1 shows a schematic diagram of a configuration of a mobile communication network using a session initiation method.

FIG. 2 shows a flowchart for representing a session initiation process guaranteeing an end-to-end quality of service (QoS) for a multimedia communication.

FIG. 3 shows a detailed diagram of a configuration of an internet protocol based mobile communication system for performing a session initiation according to an exemplary embodiment of the present invention.

FIG. 4 shows a flowchart for representing a session initiation process guaranteeing an end-to-end QoS according to the exemplary embodiment of the present invention based on the configuration shown in FIG. 3.

### BEST MODE FOR CARRYING OUT THE INVENTION

An embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

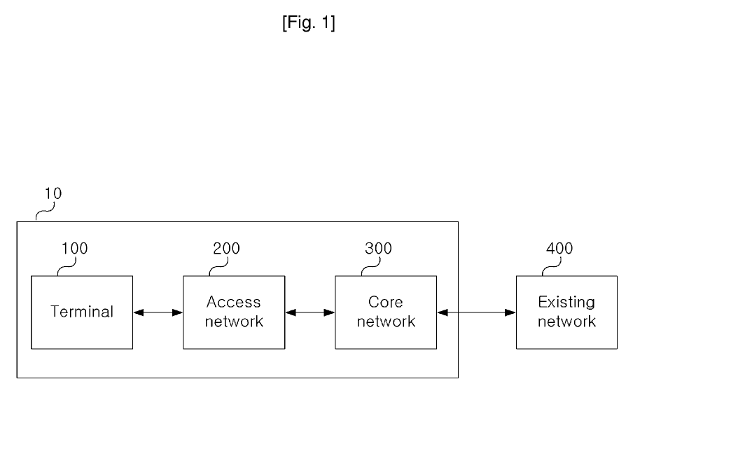

FIG. 1 shows a schematic diagram of a configuration of an internet protocol (IP) mobile communication network using a session initiation method.

As shown in FIG. 1, the mobile communication network 10 includes an access network 200 wirelessly accessed to a terminal 100, and a core network 300 formed by an IP network, the core network being linked to the access network 200.

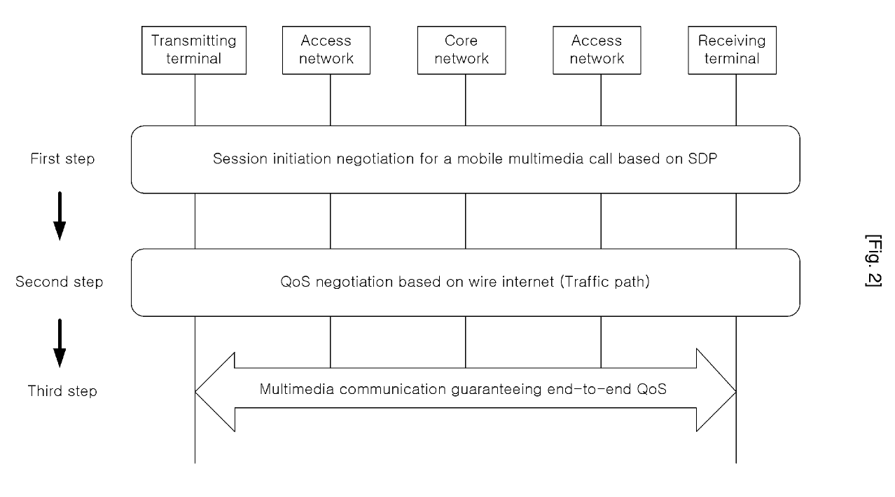

FIG. 2 shows a session initiation process in a case that mobile multimedia call is performed between terminals in the mobile communication network 10. More specifically, FIG. 2 shows a mobile multimedia session initiation process and a quality of service (QoS) negotiation process for guaranteeing a QoS in a case that multimedia call is performed between a transmitting terminal and a receiving terminal.

As shown in FIG. 2, a radio link session is controlled according to a usual process of a mobile communication system using a session description protocol (SDP) in a first step. For example, a negotiation is performed on codec resources provided between a terminal and intermediate nodes, and more specifically, the negotiation may be performed on codec types, network resources, and QoS negotiation methods.

In a second step, a QoS negotiation process for guaranteeing the QoS is performed after the negotiation for a session initiation is finished in the first step. The first step is about a negotiation process between controlling elements among network elements, and the second step is about a negotiation process between elements relating to traffic transmission. Accordingly, a session guaranteeing the end-to-end QoS is connected.

In a third step, a multimedia communication is performed. That is, a voice or a voice/image multimedia communication is performed through the connected session guaranteeing the end-to-end QoS.

As described, three steps including the session initiation (first step), QoS negotiation (second step), and end-to-end traffic transmission are required to perform a real-time multimedia session initiation guaranteeing the end-to-end QoS in the IP mobile communication system. The three steps are required because a management function including the session initiation/cancellation is performed by using a session initiation protocol (SIP) since an IP multimedia subsystem (IMS) has been used for multimedia session management in the IP mobile communication network, and because internet and mobile communication technologies have been integrated without infringing upon domains of each other.

However, it is highly required to integrate the internet and mobile communication technologies for realizing an efficient system in the IP mobile communication system for the next generation. Accordingly, operations of the IP mobile communication access network elements for improving the session initiation process and a controlling method thereof are provided in an exemplary embodiment of the present invention. More specifically, the IP mobile communication access network elements for simplifying the session initiation process by integrating the internet and mobile communication technologies and a controlling method thereof are provided.

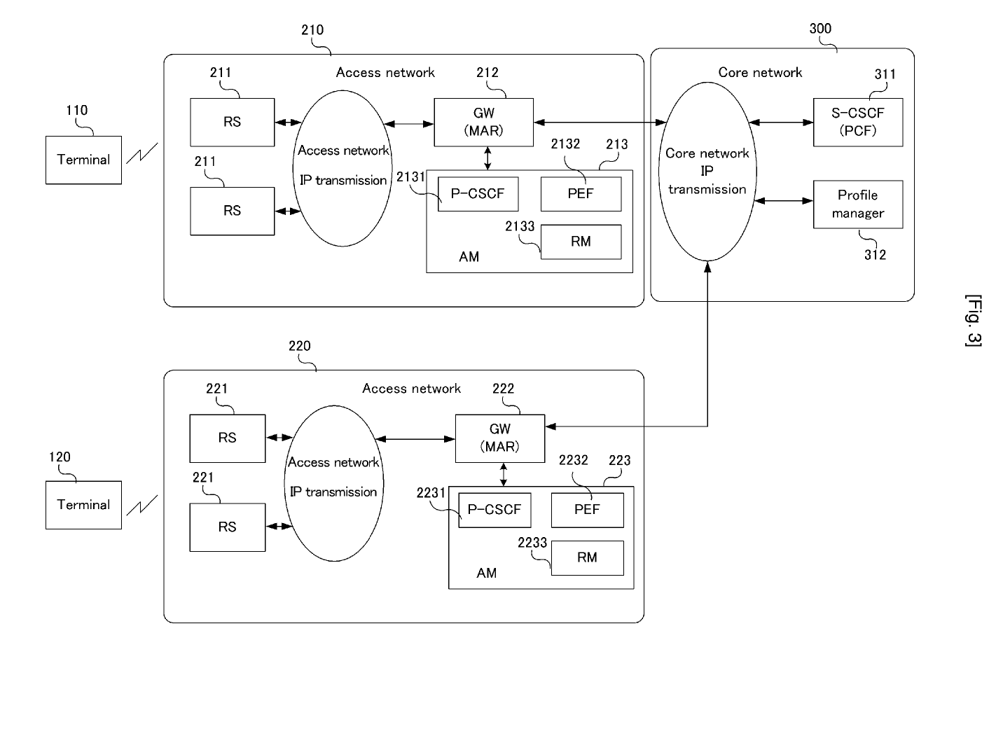

FIG. 3 shows a detailed diagram of a configuration of an IP mobile communication system for performing a session initiation according to an exemplary embodiment of the present invention.

As shown in FIG. 3, in the IP mobile communication system according to the exemplary embodiment of the present invention, terminals 110 and 120 are wirelessly accessed to access networks 210 and 220 connected to a core network 300 including an IP network.

In the exemplary embodiment of the present invention, logical functions performed in each network are separately assigned to IP transmission networks. In further detail, mobile multimedia session control and QoS control functions according to the exemplary embodiment of the present invention are separately assigned to network elements of the terminals 110 and 120, the access networks 210 and 220, and the core network 300. Accordingly, in a case of the next generation mobile multimedia communication, a communication between the terminals 110 and 120 is performed in the IP mobile communication network. In addition, the session initiation and QoS guaranteeing processes between terminals 110 and 120 of the mobile communication network for the next generation and a server or a terminal in an external existing internet network are performed in a like manner of a method used in the existing internet network.

The access networks 210 and 220 include radio stations (RS) 211 and 221, gateways (GW) 212 and 222, and access managers (AM) 213 and 223.

RSs 211 and 221 perform a radio access to the terminals 110 and 120, and the gateways 212 and 222 connected to the core network 300 operate as mobile access routers (MAR) for routing the access networks 210 and 220 and the core network 300. Accordingly, hereinafter, the gateways 212 and 222 will be referred to as the “mobile access routers”.

The AMs 213 and 223 performing basic functions of the mobile communication network specifically perform call state control, and manage radio and network resources. Accordingly, the AMs 213 and 223 according to the exemplary embodiment of the present invention include proxy-call state control function (P-CSCF) units 2131 and 2231, policy enforcement function (PEF) units 2132 and 2232 for performing a QoS policy enforcement function, and resource managers (RM) 2133 and 2233 for managing the radio and network resources.

The core network 300 includes a serving-call state control function (S-CSCF) unit 311 for performing IP/SDP signaling processes, and a profile manager 312 for managing subscribers and QoS profiles, and the S-CSCF 311 includes a policy control function (PCF) unit.

In the above configuration, the P-CSCF of a visitor network (i.e., the access network) and the S-CSCF of a home network (i.e., the core network) share a call state control function (CSCF). Specifically, the terminals 110 and 120, the AMs 213 and 223 in the access network, the S-CSCF 311, and the profile manager 312 negotiate necessary information with each other.

When the QoS is controlled according to a business policy, the AMs 213 and 223 according to the exemplary embodiment of the present invention map session and QoS information obtained in the session initiation process into a predetermined resource, and provide the information for the gateways 212 and 222 (i.e., the mobile access routers) so as to perform the QoS control function of the access network according to the result from the PCF of the core network 300 and the profile manager 312. In further detail, the AMs 213 and 223 directly control the gateways 212 and 222 by using the session and QoS information and resource management information, so that the QoS negotiation process of the second step is eliminated, since the AMs 213 and 223 have the resource managing function, policy enforcement function, proxy-call state control function, and the function and interface for controlling the mobile access routers 213 and 223.

The session initiation protocol (SIP) is used for transmitting control messages between the terminals 110, the AMs 213 and 223, and the S-CSCF 311.

Accordingly, the functions of the AMs 213 and 223 and the mobile access routers 212 and 222 having the combined function of the mobile communication and internet are defined as described above, and the session initiation for the multimedia communication is performed based on the functions of the AMs 213 and 223 and the mobile access routers 212 and 222.

The session initiation according to the exemplary embodiment of the present invention will now be described.

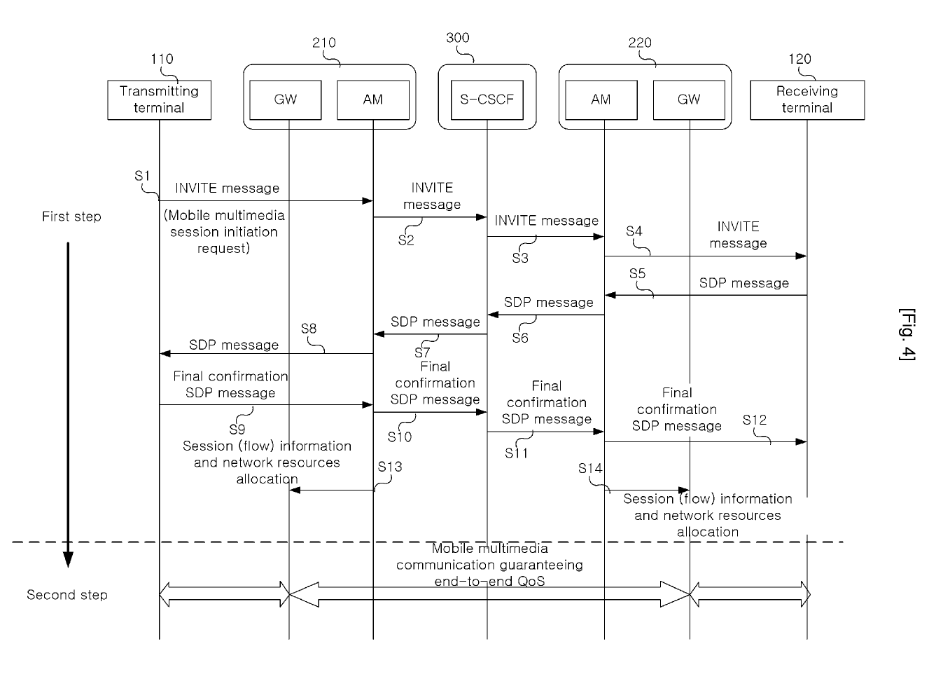

FIG. 4 shows a flowchart for representing the session initiation process according to the exemplary embodiment of the present invention. FIG. 4 shows the session initiation process being focused on transmitting control signals between network configuration elements in the mobile communication network including the session control and QoS control network elements according to the exemplary embodiment of the present invention.

A radio control process is performed between the terminal and the RS. That is, the RS allocates a radio control channel for transmitting an SIP protocol message to the terminal through an arbitrary access process performed between a radio control (RC) protocol of the terminal and the RC protocol of the RS. The session initiation process for transmitting user multimedia traffic is performed through the allocated radio control channel. According to the exemplary embodiment of the present invention, the entire session initiation process may be simplified since the end-to-end QoS negotiation is performed while the session initiation is performed.

As shown in FIG. 4, the terminal 110 transmits an INVITE message including the SDP to the access network 210 in step S1. At this time, the invite message is an SIP message used for a session connection to another side, and the terminal 110 generating the INVITE message will be referred to as a “transmitting terminal” hereinafter. In addition, the transmitted INVITE message uses a format of the INVITE message described in the request for comments (RFC) 2543 and RFC 3261 (SIP message used when a terminal performs the session connection to another terminal), and includes a field for describing the QoS information required for the radio link session initiation. The QoS information is used for performing the QoS negotiation between nodes.

The P-CSCF 2131 of the AM 213 of the access network 210 parses the transmitted INVITE message, determines if a corresponding session is the session initiation process by SIP/SDP signal exchange, and transmits the INVITE message to the core network 300 through the gateway 212 in step S2.

The S-CSCF 311 of the core network 300 examines the transmitted INVITE message and transmits the INVITE message to the access network 220 at a side of another terminal 120 (hereinafter, referred to as a “receiving terminal”) to which the transmitting terminal 110 tries to perform the session connection in step S3. At this time, the access network 220 is confirmed by the transmitting terminal 110. Accordingly, the INVITE message is transmitted to the receiving terminal 120 through the AM 223 and the gateway 222 of the access network 220 at the side of the receiving terminal in step S4. In the above process, the terminals 110 and 120 and the intermediate nodes 212, 222, 213, 223, and 311 of the respective network perform resource negotiation. That is, they negotiate the multimedia codec, the session information, and the QoS information from the transmitting terminal to the receiving terminal and between the relating network elements 212, 222, 213, 223, and 311. In the negotiation process, the respective network elements negotiate available resources of the codec type, flow information (local port number and bandwidth), and the QoS protocol (i.e., RSVP or Diffserv), and finally negotiate available end-to-end resources by negotiating the available resources for each link.

An SDP message based on the SDP as a response to the INVITE message is then transmitted to the transmitting terminal 110 connected to the access network 210 through the receiving terminal 120, the access network 220 connected to the receiving terminal 120, and the core network 300. That is, the session and QoS information negotiated between the nodes is transmitted to the transmitting terminal 110 in steps S5 to S8. The SDP message may include the QoS negotiation information provided by the access network connected to the transmitting terminal which is a destination of the INVITE message. In addition, the SDP message may also include varied QoS information when the QoS information requested by the INVITE message varies.

A final confirmation process is performed for the session and QoS information negotiated between the nodes between the transmitting terminal 110 and the receiving terminal 120. That is, a final confirmation SDP message for the finally confirmed negotiation information is transmitted from the transmitting terminal 110 to the receiving terminal 120 through the respective nodes 212, 213, 311, 222, and 223 in steps S9 to S12.

As described above, the final confirmation for the information negotiated between the respective nodes 212, 213, 311, 222, and 223 is performed for the session initiation for the multimedia communication between the transmitting terminal 110 and the receiving terminal 120.

After transmitting the final confirmation SDP message to the S-CSCF 311 of the core network 300, the AM 213 of the access network 210 at the side of the transmitting terminal controls the gateway 212 in step S13 by transmitting the session and QoS information obtained by performing the steps S1 to S12 and the network resource allocation information to the gateway 212 of the access network 210 at the side of the transmitting terminal.

In a like manner, the AM 223 of the access network 220 at the side of the receiving terminal controls the gateway 222 of the access network 220 at the side of the receiving terminal in step S14 by transmitting the session and QoS information and the network resource allocation information to the gateway 222.

Accordingly, the first step for the mobile multimedia call guaranteeing the end-to-end QoS (i.e., the session initiation and QoS negotiation process) is finished, and the second step for the multimedia communication (i.e., the traffic transmission process) is started.

As described above, according to the exemplary embodiment of the present invention, the session initiation process may be reduced by performing the end-to-end QoS negotiation between both ends and the gateways while the session initiation negotiation is performed. The session initiation process may be reduced since a negotiation processes between traffic transmission functions relating to the traffic transmission and the negotiation process between the control elements are concurrently performed by performing the end-to-end QoS guaranteed mobile multimedia communication process performed by combining the mobile communication network elements and internet network elements (i.e., the AM of the access network and the mobile access router which is the gateway are closely combined and performed.)

In addition, it is appropriate that the traffic transmission nodes of the core network are to be a managed IP network.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Throughout this specification and the claims which follow, unless explicitly described to the contrary, the word “comprise” or variations such as “comprises” or “comprising” will be understood to imply the inclusion of stated elements but not the exclusion of any other elements.

1. A session initiation method of an internet protocol (IP) mobile communication system having an access network connected between a terminal and a core network, the access network comprising a radio station wirelessly accessed to the terminal, a gateway connected to the radio station to perform a routing function, and an access manager for controlling a network access through the gateway, the session initiation method comprising:
a) the radio station establishing a radio control channel for transmitting a message according to a service request of the terminal;
b) the radio station receiving a session initiation request from the terminal through the established radio control channel, exchanging messages between the terminal and a serving-call session control function (S-CSCF) unit of the core network through the gateway, and concurrently performing a radio link session control process, resource allocation, and quality of service (QoS) negotiation; and
c) the access manager controlling an operation of the gateway to perform traffic transmission to the terminal, based on session and QoS information and resource allocation information obtained by performing the session control process.

2. The session initiation method of claim 1, wherein b) comprises:
the access manager receiving an INVITE message from the terminal through the established radio control channel, the INVITE message including the QoS information for the radio link session initiation;
the access manager extracting the QoS information by parsing the INVITE message, and transmitting the received INVITE message to the S-CSCF unit of the core network;
the access manager receiving a session description protocol (SDP) message as a response to the INVITE message of the terminal from the S-CSCF, and
transmitting the SDP message to the terminal, the SDP message storing QoS negotiation information provided from the access network connected to a receiving terminal which is a destination of the INVITE message; and
the access manager receiving a final confirmation message for the SDP message from the terminal, transmitting the final confirmation message to the S-CSCF unit of the core network, and performing a final confirmation on the negotiated information.

3. The session initiation method of claim 1 or claim 2, wherein, in c),
the access manager allocates predetermined resources to the gateway according to the QoS information negotiated based on a network resource management state, so as to perform the traffic transmission to the terminal through the allocated resources.

4. The session initiation method of claim 2, wherein the SDP message includes varied QoS information when the QoS information requested by the INVITE message varies.

5. An internet protocol (IP) mobile communication system connected between a mobile communication terminal and a core network, the IP mobile communication system comprising:
a gateway for performing a routing function, the gateway connected to the radio station accessed to the mobile communication terminal; and
an access manager for receiving a session initiation request of the terminal, exchanging messages between a serving-call session control function (S-CSCF) unit of the core network and the terminal through the gateway, and concurrently performing a radio session control process, resource allocation, and QoS negotiation.

6. The IP mobile communication system of claim 5, wherein the access manager comprises:
a resource manager for managing radio and network resources;
a proxy-call state control function (P-CSCF) unit for controlling a call state for the terminal connected through the radio station, exchanging messages according to the session initiation request, and performing a session initiation function; and
a policy enforcement function (PEF) unit for performing QoS policy in co-operation with the S-CSCF of the core network based on a radio and network resource management state.

7. The IP mobile communication system of claim 5 or claim 6, wherein:
a first message according to the session initiation request transmitted from the terminal is formed in a session initiation protocol (SIP) message format, and includes QoS information for the radio session initiation; and
a second message transmitted from the S-CSCF of the core network as a response to the first message includes QoS negotiation information provided from an access network connected to a receiving terminal which is a destination of the first message.
